(19) United States
(12) Patent Application Publication
(10) Pub. No.: US 2017/0142633 A1
(43) Pub. Date: May 18, 2017

(54) WIRELESS COMMUNICATION DEVICE AND WIRELESS COMMUNICATION SYSTEM

(71) Applicant: KABUSHIKI KAISHA TOSHIBA, Minato-ku (JP)

(72) Inventors: Yuji TOHZAKA, Kawasaki (JP); Fumiaki KANAYAMA, Kawasaki (JP); Hiroki Kudo, Kawasaki (JP); Ren Sakata, Yokohama (JP)

(73) Assignee: KABUSHIKI KAISHA TOSHIBA, Minato-ku (JP)

(21) Appl. No.: 15/264,972

(22) Filed: Sep. 14, 2016

(30) Foreign Application Priority Data
Nov. 17, 2015 (JP) 2015-224793

(51) Int. Cl. H04W 40/10; H04W 40/12; H04W 76/02

(52) U.S. Cl. CPC H04W 40/10; H04W 76/027; H04W 40/12

(57) ABSTRACT

A wireless communication device according to one of the embodiments has: a transmitter configured to transmit information; and a controller configured to control the transmitter. The controller calculates a communication amount for additional communication with another device on the basis of power information indicating a power state of a power supply; and determines whether the wireless communication device connect to the another device at least in part based on the calculated communication amount.

### CROSS REFERENCE TO RELATED APPLICATIONS

This application is based upon and claims the benefit of priority from the prior Japanese Patent Application No. 2015-224793, filed on Nov. 17, 2015, the entire contents of which are incorporated herein by reference.

### FIELD

Embodiments described herein relate to a wireless communication device and a wireless network.

### BACKGROUND

As the topology of a wireless sensor network, a mesh type network and a tree type network have been proposed. In the wireless sensor network having the topology described above, nodes of the network are configured by wireless communication devices including sensors. Sensor data transmitted by the wireless communication devices are relayed by other wireless communication devices and transferred to an aggregation device.

In such a wireless sensor network, the life of the network depends on residual power of the wireless communication devices configuring an information communication route. Therefore, there has been proposed a wireless sensor network in which the life of the network is extended by configuring an information communication route taking into account residual power of wireless communication devices.

In this wireless sensor network, the residual power is calculated on the basis of power consumption and an operation period. However, since the power consumption is a fixed value, it is difficult to accurately calculate actual residual power. In addition, when the wireless communication devices include environmental power generation devices, the residual power cannot be calculated. As a result, in the conventional wireless sensor network, the life of the network cannot be sufficiently extended.

### BRIEF DESCRIPTION OF THE DRAWINGS

FIG. 1 is a diagram showing an example of a wireless network according to a first embodiment;

FIG. 2 is a diagram showing an example of a wireless communication device according to the first embodiment;

FIG. 3 is a diagram showing an example of a functional configuration of a connection manager according to the first embodiment;

FIG. 4 is a flowchart for explaining normal processing of the wireless communication device according to the first embodiment;

FIG. 5 is a flowchart for explaining calculation processing for a residual number of connections according to the first embodiment;

FIG. 6 is a flowchart for explaining connection acceptance processing of the wireless communication device according to the first embodiment;

FIG. 7 is a flowchart for explaining parent candidate search processing of the wireless communication device according to the first embodiment;

FIG. 8 is a diagram showing an example of a functional configuration of a connection manager according to a second embodiment;

FIG. 9 is a flowchart for explaining normal processing of a wireless communication device according to a third embodiment;

FIG. 10 is a flowchart for explaining parent candidate search processing of the wireless communication device according to the third embodiment;

FIG. 11 is a diagram showing an example of a functional configuration of a connection manager according to the third embodiment;

FIG. 12 is a diagram showing an example of a wireless communication device according to a fourth embodiment;

FIG. 13 is a diagram showing an example of a functional configuration of a connection manager according to the fourth embodiment; and

FIG. 14 is a flowchart for explaining parent candidate search processing of the wireless communication device according to the fourth embodiment.

### DETAILED DESCRIPTION

A wireless communication device according to one of the embodiments has: a transmitter configured to transmit information; and a controller configured to control the transmitter. The controller calculates a communication amount for additional communication with another device on the basis of power information indicating a power state of a power supply; and determines whether the wireless communication device connect to the another device at least in part based on the calculated communication amount.

Embodiments are explained below with reference to the drawings.

### First Embodiment

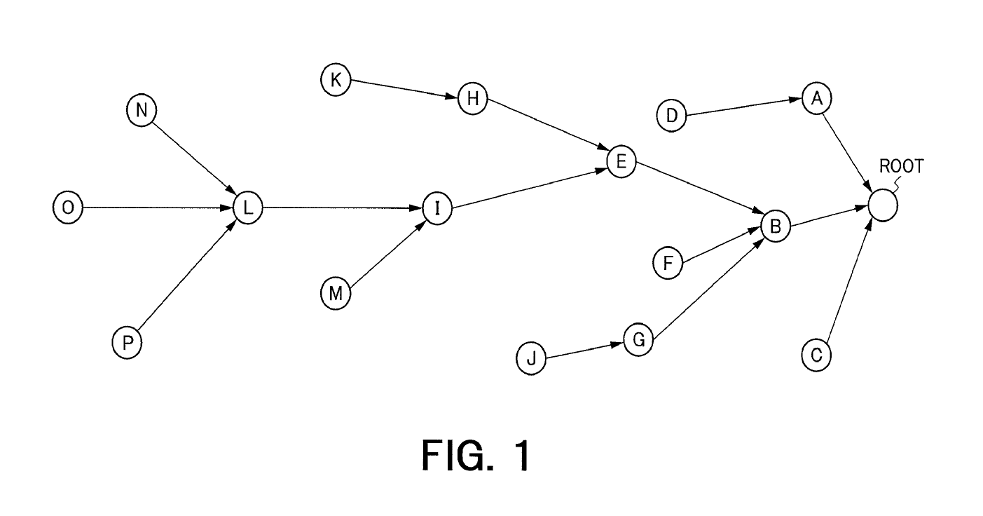

First, an overview of a wireless network according to a first embodiment is explained with reference to FIG. 1. The wireless network according to this embodiment has a mesh structure or a tree structure and is configured by a plurality of wireless communication devices. The wireless network is usable as a wireless sensor network. FIG. 1 is a diagram showing an example of the wireless network according to this embodiment.

In the example shown in FIG. 1, the wireless network has the tree structure and is configured by wireless nodes A to P and a root node. The wireless nodes A to P are respectively wireless communication devices. The root node is an aggregation device (e.g., a base station) that aggregates information transmitted by the wireless communication devices.

Arrows shown in FIG. 1 indicate connection relations among the nodes. Information is transmitted from a source node of an arrow (a child node) to a destination node of the arrow (a parent node). In the example shown in FIG. 1, a parent node of the wireless node I is the wireless node E. Child nodes of the wireless node I are the wireless nodes L and M.

In the wireless network shown in FIG. 1, the wireless nodes add information of the own nodes to information received from child nodes and transmit the information to parent nodes. Consequently, the information transmitted by the wireless nodes is relayed by the other wireless nodes and transferred to the root node.

In the following explanation, the number of times of transmission (=the number of times of relay+1) until information transmitted by the wireless nodes reaches the root node is referred to as the number of hops. In the example shown in FIG. 1, information transmitted by the wireless node I is relayed (transmitted) by the wireless nodes E and B and then reaches the root node. Therefore, the number of hops of the wireless node I is three.

The wireless network shown in FIG. 1 operates, for example, using time division communication. In the time division communication, a frame is set and the frame is a period equivalent to one cycle of the operation of the wireless network. The frame is divided into a plurality of slots. The slots are allocated as periods of predetermined operations (transmission, reception, and the like) of the wireless nodes.

For example, when a period of the frame is one hour and the frame is divided into sixty slots, a period of each of the slots is one minute. When a certain slot X of this frame is allocated as a transmission slot in which the wireless node I transmits information, the wireless node I transmits the information in slot X of the frame. As a result, the wireless node I transmits the information in every one hour. In this way, in the time division communication, the operations of the wireless nodes are repeated in every period of the frame.

Note that an operation method of the wireless network is not limited to the method explained above. For example, the wireless network may operate using a protocol based on IEEE 802. 15. 4 or may use other protocols. In any cases, it is sufficient that the same protocol is specified in wireless communication devices in the same network.

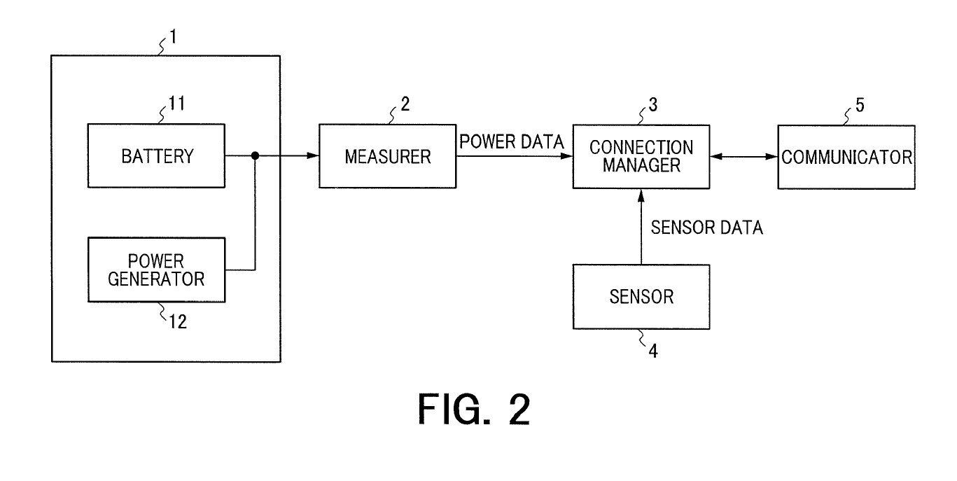

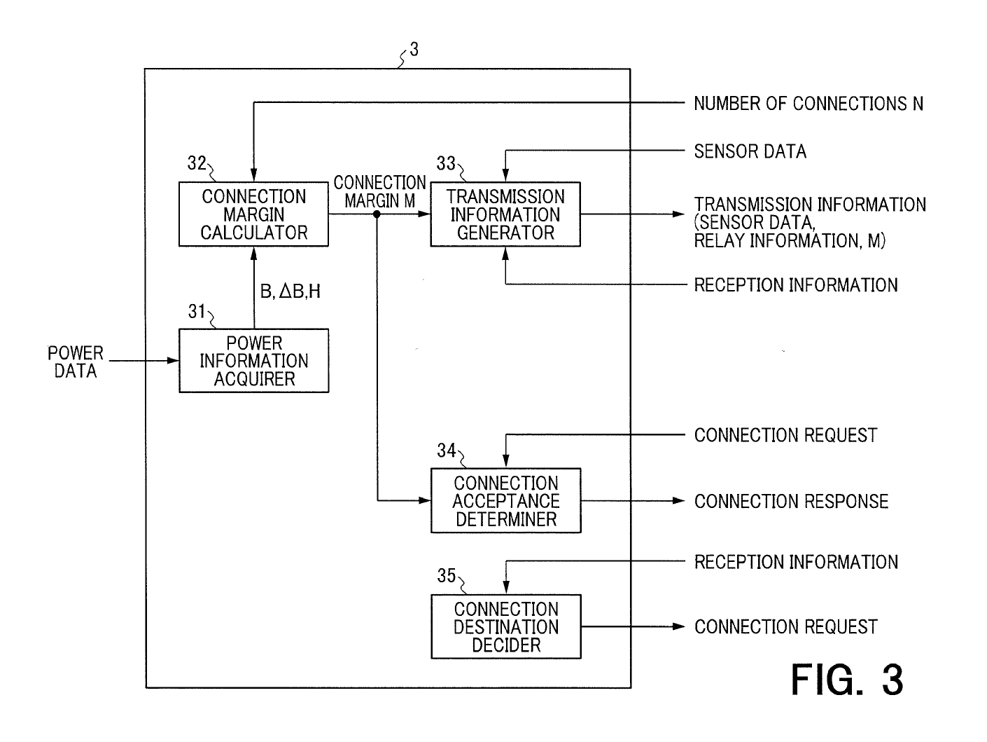

The configuration of the wireless communication device according to this embodiment is explained with reference to FIGS. 2 and 3. The wireless communication device according to this embodiment autonomously configures the wireless network of the tree structure or the mesh structure explained above. FIG. 2 is a diagram showing an example of the wireless communication device according to this embodiment. The wireless communication device shown in FIG. 2 includes a power supply 1, a measurer 2, a connection manager 3, a sensor 4, and a communicator 5.

The power supply 1 supplies electric power to the other components (the measurer 2, the connection manager 3, the sensor 4, and the communicator 5). The power supply 1 includes a battery 11 and a power generator 12.

The battery 11 supplies accumulated power to the other components. The battery 11 is, for example, a primary battery, a secondary battery, a UPS (Uninterruptible Power Supply), a super capacitor, or a combination of the foregoing but is not limited to these.

The power generator 12 is an environmental power generation device that generates power using energy around the power generator 12. The power generator 12 charges the generated power in the battery 11 and supplies the generated power to the other components. The power generator 12 is, for example, a solar power generation device including a solar panel, a thermal power generation device including a thermoelectric element, a vibration power generation device including a piezoelectric element, or a combination of the foregoing but is not limited to these.

Note that the wireless communication device shown in FIG. 2 includes the battery 11 and the power generator 12. However, a configuration not including the power generator 12 is also possible. Further, the wireless communication device does not have to include the power supply 1 and may be supplied with electric power from an external power supply.

The measurer 2 measures data (power data) concerning the electric power of the power supply 1 and outputs the measured power data. The power data includes a voltage value and a current value of the power supply 1. The measurer 2 is configured by measurement instruments (a voltmeter, an ammeter, a wattmeter, and the like) for measuring the power data. The power data output by the measurer 2 is input to the connection manager 3.

The connection manager 3 manages connection to other devices on the basis of the power data input from the measurer 2. The connection manager 3 is configured by a computer including a processor and a storage. The connection manager executes an arithmetic operation and control concerning management of connection. A server, a client, a microcomputer, and a general-purpose computer are included in the computer.

As the processor, for example, a general-purpose processor, a central processing unit (CPU), a microprocessor, a digital signal processor (DSP), a controller, a microcontroller, a state machine, an application specific integrated circuit, a field programmable gate array (FPGA), a programmable logic circuit (PLC), and a combination of the foregoing can be used.

As the storage, for example, non-transitory tangible computer readable storage media such as a RAM, a DRAM, an SRAM, a hard disk, an optical disk, a flash memory, and a magnetic tape can be used.

The connection manager 3 will be later explained in detail.

The sensor 4 measures a state around the wireless communication device and outputs obtained data (sensor data). The sensor data includes data such as temperature, humidity, acceleration, pressure, magnetism, and an image. The sensor data output by the sensor 4 is input to the connection manager 3 and transmitted to the parent node in a payload of the wireless communication device.

The communicator 5 communicates with other wireless communication devices including the aggregation device by radio and executes transmission and reception of information. The transmission and reception of the information of the communicator 5 is controlled by the connection manager 3. The communicator 5 includes a digital signal processing circuit, an analog signal processing circuit, and an analog frontend. The communicator 5 performs wireless communication using a specified communication protocol. As the communicator 5, an existing wireless communication device can be used.

FIG. 3 is a diagram showing an example of a functional configuration of the connection manager 3. The connection manager 3 shown in FIG. 3 includes a power information acquirer 31, a connection margin calculator 32, a transmission information generator 33, a connection acceptance determiner 34, and a connection destination decider 35. These functional components correspond to functions of the connection manager 3. The functional components are realized by the processor of the connection manager 3 executing a program stored in the storage.

The power information acquirer 31 acquires power information on the basis of the power data input from the measurer 2. The power information indicates a power state of the power supply 1. The power information includes at least one kind of residual electric energy B (J), a power change amount ΔB (W), and a power generation amount H (W). The residual electric energy B is electric energy accumulated in the battery 11. The power change amount ΔB is a change amount of the residual electric energy B per unit time. The power generation amount H is a power generation amount of the power generator 12 per unit time. Specific examples of an acquisition method for the power information are hereinafter explained.

<First Acquisition Method>

When a voltage value of the battery 11 is obtained as the power data, the power information acquirer 31 can compare a voltage value of the battery 11 at time t₀ with a discharge characteristic of the battery 11 and calculate residual electric energy B₀ at time t₀. The power information acquirer 31 needs to store the discharge characteristic of the battery 11 measured in advance.

With this method, the power change amount ΔB from time t₀ to time t₁ can be calculated as a time average of a difference between the residual electric energy B₀ at time t₀ and residual electric energy B₁ at time t₁. That is, ΔB=(B₁−B₀)/(t₁−t₀).

On the other hand, the power information acquirer 31 may store history data of the voltage value of the battery 11, compare a stored change in the voltage value with the discharge characteristic of the battery 11, and calculate the residual electric energy B after a predetermined period from the present time.

<Second Acquisition Method>

When the power generation amount H=0, a consumed current amount in the predetermined period of the battery 11 is equivalent to a change amount of the residual electric energy B in the predetermined period. Therefore, when the power generation amount H=0 and a current value of the battery 11 is obtained as the power data, the power information acquirer 31 stores history data of the current value of the battery 11 and calculates, as the power change amount ΔB, a time average of a sum (an integrated value) of current values in the predetermined period.

With this method, the residual electric energy B₁ at time t₁ can be calculated as a sum of the residual electric energy B₀ at time t₀ and a time product of the power change amount ΔB from time t₀ to time t₁. That is, B₁=B₀+ΔBx(t₁−t₀).

Note that the case in which the power generation amount H=0 includes both the case in which the power generator 12 is not generating power and the case in which the power supply 1 does not include the power generator 12. The same applies to a third acquisition method explained below.

<Third Acquisition Method>

When the power generation amount H=0, a power consumption amount in the predetermined period of the wireless communication device is equivalent to a change amount of the residual energy B in the predetermined period. Therefore, when the power generation amount H=0, the power information acquirer 31 may store in advance power consumption amounts in respective kinds of transmission and reception processing of the communicator 5 and a power consumption amount in the case in which one other device is connected to the own device, observe the number of times of transmission and reception in the predetermined period and the number of connected other devices, calculate a power consumption amount in the predetermined period, and calculate a time average of the power consumption amount (a power consumption amount C (W) per unit time) as the power change amount ΔB.

With this method, the residual electric energy B₁ at time t₁ can be calculated as a sum of the residual electric energy B₀ at time t₀ and the time product of the power change amount ΔB from time t₀ to time t₁. That is, B₁=B₀+ΔBx(t₁−t₀).

<Fourth Acquisition Method>

When the power generation amount H>0, the power change amount ΔB is a difference between the power generation amount H and the power consumption amount C per unit time (ΔB=H−C). In this case, firstly, the power information acquirer 31 calculates the residual electric energy B and the power change amount ΔB according to the first acquisition method. Subsequently, the power information acquirer 31 stores in advance power consumption amounts in respective kinds of transmission and reception processing of the communicator 5 and a power consumption amount in the case in which one other device is connected to the own device, observes the number of times of transmission and reception and the number of connected other devices in the predetermined period, calculates a power consumption amount in the predetermined period, and calculates a time average of the power consumption amount (the power consumption amount C per unit time). The power information acquirer 31 calculates a sum of the power change amount ΔB and the power consumption amount C as the power generation amount H.

For example, when the predetermined time is a period from time t₀ to time t₁, the power consumption amount C depends on only the number of connected other devices connected to the own device, and the consumed power amount in the case in which one other device is connected is E₀ (W), the power generation amount H can be calculated by the following equation:

H=(B₁−B₀)/(t₁−t₀)−N×E₀ (1)

In Equation (1), “N” represents an average number of connected devices from time t₀ to time t₁. A first term on the right side of Equation (1) is equivalent to the power change amount ΔB and a second term is equivalent to the power consumption amount C.

Note that the acquisition method by the power information acquirer 31 is not limited to the methods explained above. The power information acquirer 31 may acquire physical quantities equivalent to the residual electric energy B, the power change amount ΔB, and the power generation amount H, as the power information, instead of them. The power information acquirer 31 outputs the power information acquired in this way to the connection margin calculator 32.

The connection margin calculator 32 calculates a connection margin M of the own device. The connection margin M means a communication amount additionally communicable by the own device (allowed for additional communication). The connection margin M is equivalent to a difference between a communication amount communicable while the life of the own device is maintained and a present communication amount of the own device.

The connection margin calculator 32 calculates, for example, a residual data amount as the connection margin M. The residual data amount means a difference between a maximum data amount and a present data amount. The maximum data amount means a data amount (a throughput) communicable by the own device. The present data amount means a data amount currently communicated by the own device. That is, the residual data amount is a data amount additionally communicable by the own device.

The connection margin calculator 32 may calculate a residual number of connections as the connection margin M. The residual number of connections means a difference between a maximum number of connections L and the number of current connections N. The maximum number of connections L means the number of other devices connectable to the own device. The number of current connections N means the number of other devices currently connected to the own device. That is, the residual number of connections means the number of other devices additionally connectable to the own device. Note that the number of connections N may be the number of parent nodes and child nodes being connected or may be the number of only child nodes being connected.

The connection margin M changes depending on a state of the power supply 1 of the own device. The connection margin M is larger as the residual electric energy B, the power change amount ΔB, and the power generation amount H are larger. This is because an allowable amount is larger as the residual electric energy B, the power change amount ΔB, and the power generation amount H are larger.

Therefore, connection margin calculator 32 calculates the present connection margin M of the own device on the basis of the residual electric energy B, the power change amount ΔB, and the power generation amount H input from the power information acquirer 31. Note that the connection margin M is not limited to the residual number of connections and the residual communication amount. In the following explanation, an example is explained in which the connection margin M is the residual number of connections.

First, the connection margin calculator 32 calculates the maximum number of connections L on the basis of the residual electric energy B, the power change amount ΔB, and the power generation amount H. When the power generation amount H=0, the maximum number of connections L can be calculated by the following equation:

L=Q(B/|ΔB|) (2)

In Equation (2), B/|ΔB| is time until the residual electric energy B decreases to 0. When the power generation amount H=0, since the power change amount ΔB is a negative value, an absolute value is given to the power change amount ΔB. In Equation (2), Q(X) is a function for converting the time until the residual electric energy B decreases to 0 into the maximum number of connections. According to the function Q(X), as B/|ΔB| is longer, the maximum number of connections L is larger.

Note that the function Q(X) may be calculated by an experiment in advance. Instead of the function Q(X), a table indicating a correspondence relation between B/|ΔB| and the maximum number of connections L may be used. Furthermore, when the power generation amount H is equal to or smaller than a predetermined threshold H_{TH}, the connection margin calculator may calculate the maximum number of connections L according to Equation (2).

On the other hand, when the power generation amount H>0, the maximum number of connections L can be calculated by the following Equation.

L={H/C} (3)

In Equation (3), {X} represents a floor function. The power consumption amount C per unit time may be calculated by a method same as the fourth acquisition method explained above. “H” on the right side of Equation (3) may be replaced with (H+B) or (B+ΔB). By setting “H” on the right side of Equation (3) to (H+B+τ×ΔB) and setting τ to any time, a numerator on the right side may be set as a predicted value of the residual electric energy B in future. Consequently, it is possible to calculate the maximum number of connections L taking into account the residual electric energy B.

Note that, even when H>0, when ΔB<0, the maximum number of connections L may be calculated according to Equation (2). The case in which H>0 and ΔB<0 is equivalent to the case in which the power consumption amount C is larger than the power generation amount H.

Subsequently, the connection margin calculator 32 acquires the present number of connections N from the communicator 5. When the communicator 5 does not have the number of connections N stored therein, for example, the connection margin calculator 32 may acquire, from the communicator 5, IDs (identification information) of a parent node and a child node currently being connected and count the acquired IDs to thereby acquire the number of connections N.

The connection margin calculator 32 calculates the residual number of connections M according to the following equation:

M=L−N (4)

The connection margin calculator 32 inputs the residual number of connections M calculated in this way to the transmission information generator 33 and the connection acceptance determiner 34. Note that a calculation method for the residual number of connections M is not limited to the calculation method explained above. For example, the connection margin calculator 32 may set M to 1 when ΔB is equal to or larger than 0 and may set M to 0 when ΔB is smaller than 0. Consequently, it is possible to notify only connection availability to reduce the number of bits necessary for the notification and simplify processing.

The transmission information generator 33 generates transmission information that the own device transmits to the parent node. The transmission information includes an ID of the own device, an ID of the parent node, which is a transmission destination, the residual number of connections (the connection margin) M input from the connection margin calculator 32, sensor data acquired from the sensor 4, and relay information.

The relay information means reception information that the own device has received from the child node. The reception information is transmission information that the child node has transmitted to the own device. The transmission information generator 33 acquires the reception information from the communicator 5 and makes the reception information be included in the transmission information as relay information.

The transmission information generator 33 inputs the generated transmission information to the communicator 5. The communicator 5 transmits the input transmission information by radio.

A connection request from another device to the own device is input to the connection acceptance determiner 34 by the communicator 5. When the connection request is received, the connection acceptance determiner 34 determines on the basis of the residual number of connections M input from the connection margin calculator 32 whether the connection request from the other device is accepted. The connection acceptance determiner 34 permits the connection if a connection margin is large but rejects the connection if the connection margin is small. For example, when the residual number of connections M is equal to or larger than a threshold M_{TH}, the connection acceptance determiner 34 accepts the connection. When the residual number of connections M is smaller than the threshold M_{TH}, the connection acceptance determiner 34 rejects the connection. The connection acceptance determiner 34 inputs a connection response corresponding to a determination result to the communicator 5. The communicator 5 transmits the input connection response by radio. Note that the threshold M_{TH} can be optionally set and is, for example, 1.

The connection destination decider 35 operates when the own device searches for a new parent node. The search for a new parent node is performed when the own device participates in a wireless network anew or when a parent node is changed. The change of the parent node is performed when the parent node becomes unable to communicate because of a failure or when link quality of wireless communication with the parent node is deteriorated. The change of the parent node may be performed at a predetermined time interval. Consequently, it is possible to update a parent node of the own device to an optimum parent node at any time.

When searching for a new parent node, the connection destination decider 35 causes the communicator 5 to execute reception processing for a predetermined period. This period is hereinafter referred to as a parent candidate search period. The parent candidate search period is, for example, one frame.

Reception information received by the communicator 5 in the parent candidate search period is input to the connection destination decider 35. The reception information is equivalent to transmission information of another device. Therefore, the reception information includes an ID of the other device and the residual number of connections (the connection margin) M of the other device.

When the reception information is input, the connection destination decider 35 stores the ID and the residual number of connections M of the other device in association with each other. After the end of the parent candidate search period, the connection destination decider 35 decides a parent candidate on the basis of the stored residual number of connections M. The parent candidate means another device to be a candidate of a new parent node.

The connection destination decider 35 decides, for example, another device having the largest residual number of connections M as the parent candidate. When there are a plurality of other devices having the largest number of residual connections M, the connection destination decider 35 may decide the parent candidate at random out of the other devices having the largest number of residual connections M.

The connection destination decider 35 generates a connection request to the determined parent candidate. The connection request includes an ID of the parent candidate as a transmission destination. The connection destination decider inputs the generated connection request to the communicator 5. The communicator 5 transmits the input connection request by radio.

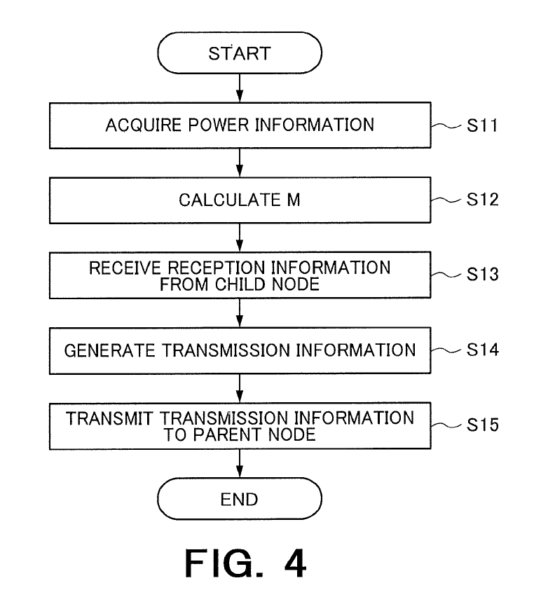

The operation of the wireless communication device according to this embodiment is explained with reference to FIGS. 4 to 7. FIG. 4 is a flowchart for explaining normal processing of the wireless communication device. The wireless communication device repeats the operation of the flowchart of FIG. 4 at a predetermined time interval.

In the following explanation, it is assumed that the wireless communication device repeats the operation of the flowchart of FIG. 4 for each of frames. A transmission slot in which transmission processing is executed and a reception slot in which reception processing is executed are set in the wireless communication device in advance. The reception slot of the wireless communication device is set to at least partially overlap a transmission slot of a child node.

First, the power information acquirer 31 acquires the power information (B, ΔB, and H) on the basis of power data input from the measurement unit 2 (step S11). The acquisition method for the power information is as explained above. The measurer 2 may continuously input the power data to the power information acquirer 31 or may input the power data in response to a request from the power information acquirer 31. The power information acquirer 31 may acquire the power information only once in each of the frames or may acquire the latest power information at a predetermined time interval. The power information acquirer 31 stores the acquired power information.

Subsequently, the connection margin calculator 32 acquires the latest power information from the power information acquirer 31 and calculates the residual number of connections M (step S12). The power information acquirer 31 may input the acquired power information to the connection margin calculator 32 every time the power information acquirer 31 acquires the power information or may input the latest power information to the connection margin calculator 32 in response to a request from the connection margin calculator 32. The connection margin calculator 32 stores the calculated residual number of connections M and inputs the calculated residual number of connections M to the transmission information generator 33 and the connection acceptance determiner 34. Calculation processing for the residual number of connections M will be later explained in detail.

When a reception slot of the own device comes, the communicator 5 starts reception processing and receives reception information from the child node by radio (step S13). When receiving the reception information, the communicator 5 checks whether the reception information is addressed to the own device. That is, the communicator 5 checks whether an ID of a transmission destination of the reception information is the ID of the own device. When the reception information is addressed to the own device, the communicator 5 inputs the reception information to the transmission information generator 33. The transmission information generator 33 stores the input reception information. The wireless communication device continues the reception processing explained above in the reception slot.

Note that step S13 may be performed before step S11 and step S12. The transmission information generator 33 may execute the check of a destination of the reception information. When there are a plurality of child nodes, a plurality of the reception slots may be provided.

When the reception slot of the own device ends, the transmission information generator 33 generates transmission information (step S14). The transmission information includes the ID of the own device, which is a transmission source, the ID of the parent node, which is the transmission destination, sensor data input from the sensor 4, the residual number of connections M input from the connection margin calculator 32, and the reception information (relay information) stored in the reception slot. The transmission information generator 33 stores the generated transmission information.

Thereafter, when a transmission slot of the own device comes, the transmission information generator 33 inputs the generated transmission information to the communicator 5. The communicator 5 transmits the input transmission information to the parent node by radio (step S15). The communicator 5 may continuously transmit the transmission information in the transmission slot or may transmit the transmission information by a predetermined number of times. Thereby, the normal processing for one cycle of the wireless communication device ends.

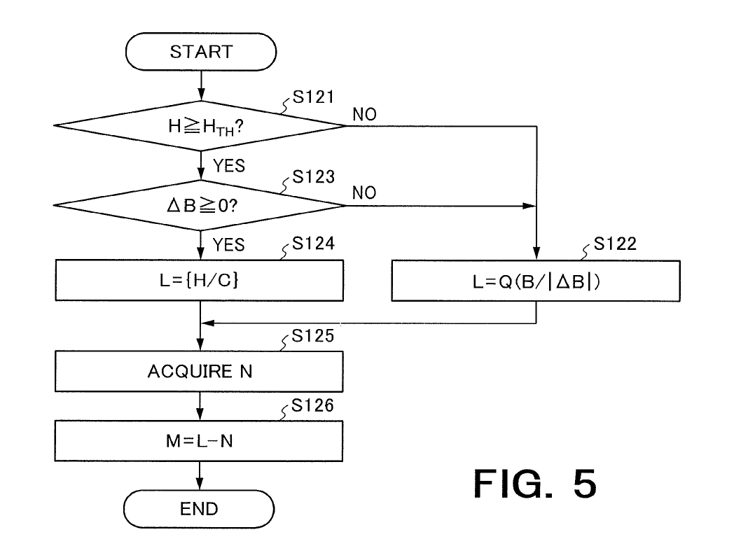

FIG. 5 is a flowchart for explaining the calculation processing (step S12) for the residual number of connections M.

Firstly, the connection margin calculator 32, which has acquired the power information (B, ΔB, and H) in step S11, determines whether the power generation amount H is equal to or larger than the threshold H_{TH} (step S121).

When the power generation amount H is smaller than the threshold H_{TH} (NO in step S121), the connection margin calculator 32 calculates the maximum number of connections L according to Equation (2) described above (step S122). That is, L=Q(B/|ΔB|).

On the other hand, when the power generation amount H is equal to or larger than the threshold H_{TH} (YES in step S121), the connection margin calculator 32 determines whether the power change amount ΔB is equal to or larger than 0 (step S123).

When the power change amount ΔB is smaller than 0 (NO in step S123), the connection margin calculator 32 calculates the maximum number of connections L according to Equation (2) described above (step S122). That is, L=Q(B/|ΔB|).

On the other hand, when the power change amount ΔB is equal to or larger than 0 (YES in step S123), the connection margin calculator 32 calculates the maximum number of connections L according to Equation (3) described above (step S124). That is, L={H/C}. The calculation method for the power consumption amount C is as explained above.

After calculating the maximum number of connections L, the connection margin calculator 32 acquires the number of connections N from the communicator 5 (step S125).

The connection margin calculator 32 calculates the residual number of connections M according to Equation (4) described above (step S126). That is, M=L-N.

Note that, when the power supply 1 does not include the power generator 12, steps S121 to S123 may be omitted. That is, the connection margin calculator 32 may calculate the residual number of connections M by executing steps S124 to S126.

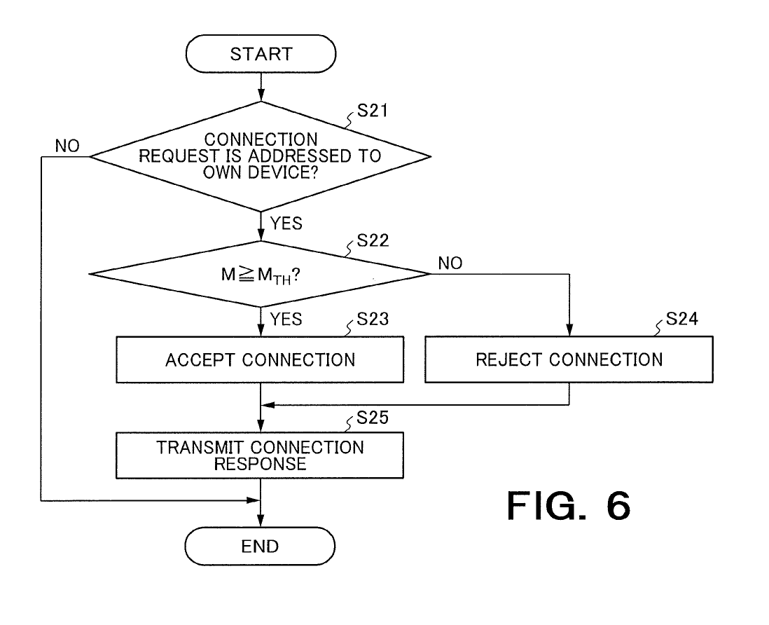

FIG. 6 is a flowchart for explaining connection acceptance processing of the wireless communication device. The connection acceptance processing means processing performed when the wireless communication device receives a connection request.

When receiving a connection request, the communicator 5 checks whether the connection request is addressed to the own device (step S21). That is, the communicator 5 checks whether an ID of a transmission destination of the connection request is the ID of the own device.

When the connection request is not addressed to the own device (NO in step S21), the connection acceptance processing ends.

On the other hand, when the connection request is addressed to the own device (YES in step S21), the communicator 5 inputs the connection request to the connection acceptance determiner 34. Note that the connection acceptance determiner 34 may execute the check of the destination of the connection request. In this case, the communicator 5 may input received all connection requests to the connection acceptance determiner 34.

The connection acceptance determiner 34, to which the connection request addressed to the own device is input, determines whether the residual number of connections M of the own device input from the connection margin calculator 32 is equal to or larger than the threshold M_{TH} (step S22). The connection margin calculator 32 may input the residual number of connections M to the connection acceptance determiner 34 every time the connection margin calculator 32 calculates the residual number of connections M or may input the residual number of connections M to the connection acceptance determiner 34 in response to a request from the connection acceptance determiner 34.

When the residual number of connections M is equal to or larger than the threshold M_{TH} (YES in step S22), the connection acceptance determiner 34 determines that connection from another device that transmits the connection request is accepted (step S23).

On the other hand, when the residual number of connections M is smaller than the threshold M_{TH} (NO in step S22), the connection acceptance determiner 34 determines that connection from the other device that transmits the connection request is rejected (step S24).

Thereafter, the connection acceptance determiner 34 generates a connection response corresponding to a determination result and inputs the connection response to the communicator 5. The communicator 5 transmits the input connection response by radio (step S25).

The other device, which has received the connection response that the connection is accepted, is subsequently connected to the own device as a child node of the own device. On the other hand, the other device, which has received the connection response that the connection is rejected, transmits a connection request to a new parent candidate.

Note that, when the connection acceptance determiner 34 determines that the connection is rejected, the connection acceptance determiner 34 does not have to generate the connection response. In this case, when the other device, which has transmitted the connection request, cannot receive the connection response in a predetermined period, the other device may deem that connection is rejected and transmit a connection request to a new parent candidate.

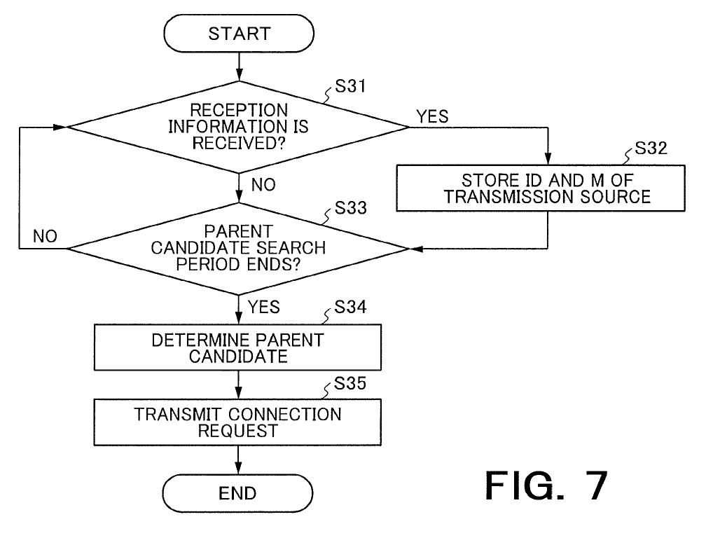

FIG. 7 is a flowchart for explaining parent candidate search processing of the wireless communication device. The parent candidate search processing means processing in which the wireless communication device searches for a new parent node.

When the parent candidate search processing is started, the connection destination decider 35 causes the communicator 5 to execute reception processing. When receiving reception information during the reception processing (YES in step S31), the communicator 5 inputs the reception information to the connection destination decider 35.

The connection destination decider 35, to which the reception information is input, stores an ID of a transmission source and the residual number of connections M of the transmission source, which are included in the input reception information, in association with each other (step S32). The communicator 5 and the connection destination decider 35 continue the processing until a parent candidate search period ends.

When the parent candidate search period ends (YES in step S33), the connection destination decider 35 causes the communicator 5 to end the reception processing. The connection destination decider 35 decides a parent candidate on the basis of the residual number of connections M stored in the parent candidate search period (step S34).

The connection destination decider 35 decides another device having the largest residual number of connections M as the parent candidate. When there are a plurality of other devices having the largest residual number of connections M, the connection destination decider 35 may determine the parent candidate at random out of the other devices having the largest residual number of connections M. When the residual numbers of connections M of all other devices are smaller than the threshold M_{TH}, the connection destination decider 35 may end the parent candidate search processing.

Thereafter, the connection destination decider 35 generates a request for connection to the determined parent candidate and inputs the connection request to the communicator 5. The communicator 5 transmits the input connection request by radio (step S35).

When the wireless communication device, which has transmitted the connection request, receives, from the parent candidate, a connection response that the connection is accepted, the wireless communication device is subsequently connected to the parent candidate as a child node of the parent candidate.

On the other hand, when the wireless communication device, which has transmitted the connection request, receives, from the parent candidate, a connection response that the connection is rejected or when the wireless communication device cannot receive a connection response from the parent candidate in a predetermined period, the wireless communication device transmits a connection request to a new parent candidate. In this case, the wireless communication device may execute the parent candidate search processing again or may determine the next parent candidate base on the residual numbers of connections M stored in the parent candidate search period.

As explained above, the wireless communication device according to this embodiment calculates the connection margin M corresponding to a power state of the power supply 1 and determines whether the wireless communication device is allowed to connect to another device on the basis of the connection margin M of the own device. Specifically, the wireless communication device accepts the connection from the other device when the connection margin M of the own device is equal to or larger than the threshold M_{TH} and rejects the connection from the other device when the connection margin M of the own device is smaller than the threshold M_{TH}.

By limiting the number of connections of the other devices to the wireless communication devices according to power states of the wireless communication devices in this way, the other devices are not excessively connected to the wireless communication devices. As a result, it is possible to extend the life of the wireless network and stabilize the network.

Note that, in this embodiment, in order to grasp the power states of the wireless communication devices, the power information acquired on the basis of the power data of the power supply 1 is used. Therefore, in this embodiment, unlike the conventional wireless sensor network, it is possible to form the wireless network on which the power states of the wireless communication devices are accurately reflected.

The connection margin calculator 32 of the present embodiment and the connection acceptance determiner 34 of the present embodiment is one of the examples of a controller in the claims.

### Second Embodiment

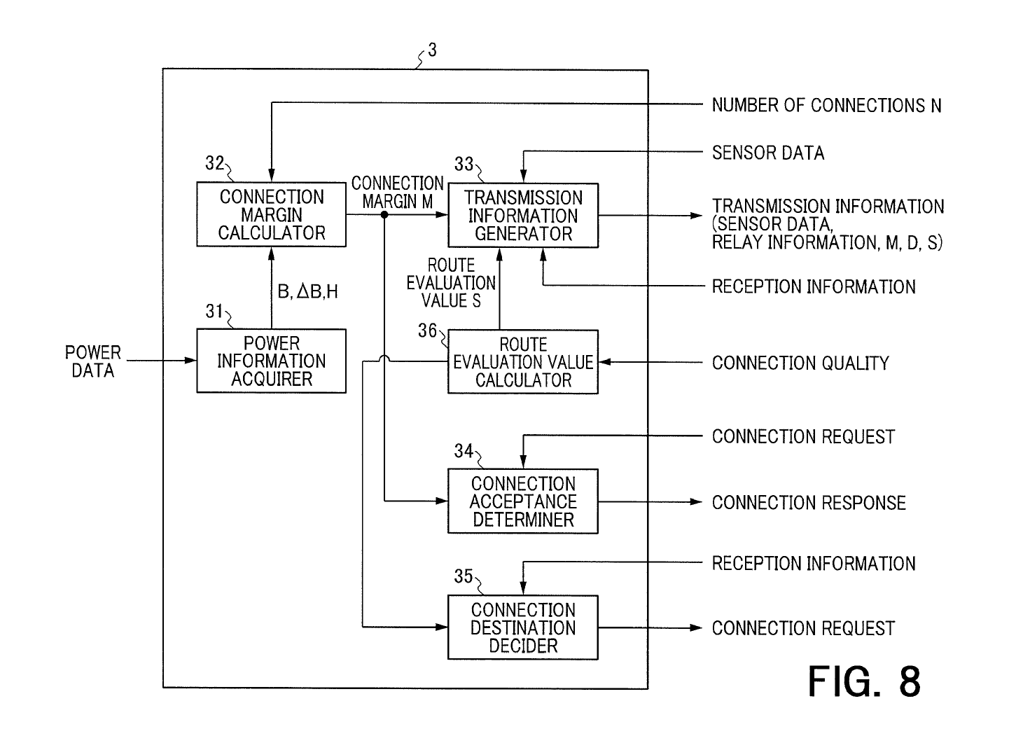

First, a wireless communication device according to a second embodiment is explained with reference to FIG. 8. The wireless communication device according to this embodiment uses the number of same type devices D and a route evaluation value S together with the connection margin M in order to determine a parent candidate.

FIG. 8 is a diagram showing an example of a functional configuration of the connection manager 3 of the wireless communication device according to this embodiment. The connection manager 3 shown in FIG. 8 includes a route evaluation value calculator 36. The other components are the same as the components of the connection manager 3. Differences from the first embodiment are mainly explained below.

In this embodiment, transmission information of wireless communication devices includes IDs of the own devices, IDs of parent nodes, which are transmission destinations, the residual numbers of connections (the connection margins) M input from the connection margin calculator 32, sensor data acquired from the sensor 4, relay information, the numbers of same type devices D, and the route evaluation values S.

The number of same type devices D means the number of all nodes (the number of nodes of the entire wireless communication device) included in a subtree, to which the own device belongs, in a wireless network. The subtree means a subtree starting from a wireless communication device, the number of hops of which is one.

In an example shown in FIG. 1, the number of same type devices D of the wireless node I is 13. This is because a subtree to which the wireless node I belongs is a subtree starting from the wireless node B, the number of hops of which is 1, and thirteen wireless communication devices (wireless nodes) are included in the subtree. All of the numbers of same type devices D of the wireless communication devices belonging to the subtree are 13.

The wireless communication device, the number of hops of which is 1, can acquire the number of same type devices D by counting the numbers of IDs of wireless communication devices and sensor data included in the reception information. The wireless communication device, the number of hops of which is 1, transmits the acquired number of same type devices D, to a child node, the number of hops of which is 2. The wireless communication device, the number of hops of which is 2, receives the number of same type devices D and transmits the number of same type devices D to a child node, the number of hops of which is 3. By repeating this, the wireless communication devices can acquire the numbers of same type devices D of the own devices. The transmission information generators 33 of the wireless communication devices stores the numbers of same type devices D of the own devices acquired in this way and generates transmission information including the numbers of same type devices D.

The route evaluation value S is a value indicating the quality of a communication route of information from the own device to the root node. The route evaluation value S is calculated on the basis of link quality among the wireless communication devices on the route.

The link quality is a quantitative value indicating the quality of connection between connected two wireless communication devices. As the link quality, for example, received electric power, RSSI (Received Signal Strength Indicator), SIR (Signal to Interference Ratio), SINR (Signal to Interference and Noise Ratio), BER (Bit Error Rate), and PER (Packet Error Rate) can be used.

In the example shown in FIG. 1, the route evaluation value S of the wireless node I is calculated on the basis of the link quality between the wireless node I and the wireless node E, the link quality between the wireless node E and the wireless node B, and the link quality between the wireless node B and the root node.

As the route evaluation value S, for example, ETX (Expected transmission count) can be used. The ETX is a value indicating the number of times of transmission including the number of times of retransmission necessary for transmitting one kind of information from an end to an end of a route. The ETX is calculated by converting respective kinds of link quality on the route into a retransmission probability. Smaller EXT means higher quality of the route. Note that the route evaluation value S is not limited to the ETX. As the route evaluation value S, a minimum, a maximum, an average, and the like of the link quality on the route may be used.

The route evaluation value calculator 36 calculates the route evaluation value S of the own device. The route evaluation value calculator 36 causes the communicator 5 to execute reception processing in a transmission slot of the parent node. When receiving transmission information of the parent node, the communicator 5 calculates the link quality between the own device and the parent node and inputs the calculated link quality and reception information to the route evaluation value calculator 36. Note that the route evaluation value calculator 36 may perform the calculation of the link quality.

The route evaluation value calculator 36 calculates the route evaluation value S of the own device on the basis of the route evaluation value S of the parent node included in the reception information (the transmission information of the parent node) and the input link quality. By calculating the route evaluation value S of the own device every time the route evaluation value calculator 36 receives the transmission information of the parent node, the route evaluation value calculator 36 can update the route evaluation value S to a value corresponding to the latest connection state.

The route evaluation value calculator 36 inputs the route evaluation value S calculated in this way to the transmission information generator 33. The transmission information generator 33 generates transmission information including the input route evaluation value S.

In the parent candidate search processing, the route evaluation value calculator 36 calculates the route evaluation value S of the own device in the case in which another device is connected as the parent node. The parent candidate search processing is explained in detail below.

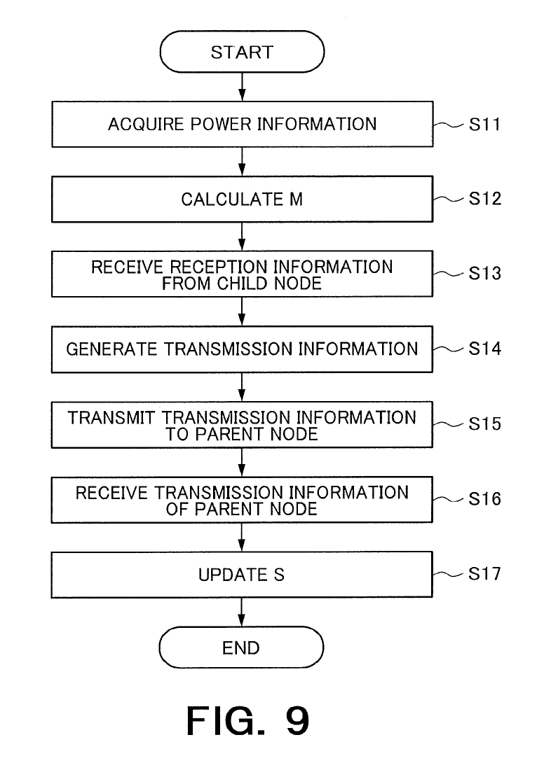

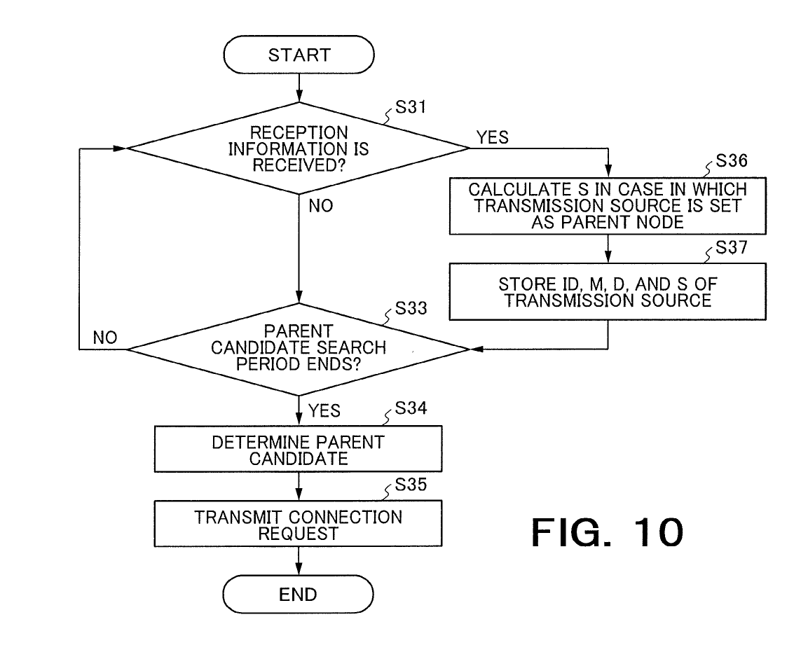

The operation of the wireless communication device according to this embodiment is explained with reference to FIGS. 9 and 10. FIG. 9 is a flowchart for explaining normal processing of the wireless communication device. Steps S11 to S13 and S15 in the flowchart of FIG. 9 are the same as the steps in the flowchart of FIG. 4.

In this embodiment, in step S14, the transmission information generator 33 generates transmission information including the number of same type devices D and the route evaluation value S.

In this embodiment, after the communicator 5 transmits the transmission information in step S15, when a transmission slot of the parent node comes, the transmission information generator 33 causes the communicator 5 to execute reception processing. Consequently, the communicator 5 receives the transmission information transmitted by the parent node (step S16).

When receiving the transmission information of the parent node, the communicator 5 calculates link quality between the own device and the parent node and inputs the calculated link quality and the received transmission information of the parent node to the route evaluation value calculator 36. The route evaluation value calculator 36 updates the route evaluation value S of the own device on the basis of the link quality and the route evaluation value S of the parent node included in the transmission information (step S17).

The route evaluation value calculator 36 inputs the updated route evaluation value S to the transmission information generator 33. The transmission information generator 33 subsequently generates transmission information including the updated route evaluation value.

When the transmission slot of the parent node ends, the transmission information generator 33 causes the communicator 5 to end the reception processing. The normal processing for one cycle of the wireless communication device ends.

FIG. 10 is a flowchart for explaining the parent candidate search processing of the wireless communication device. Steps S31, S33, and S35 in the flowchart of FIG. 10 are the same as the steps in the flowchart of FIG. 7.

In this embodiment, when receiving reception information during the reception processing (YES in step S31), the communicator 5 inputs the reception information to the connection destination decider 35. At the same time, the communicator 5 calculates link quality between the own device and a transmission source of the reception information and inputs the calculated link quality and the received reception information to the route evaluation value calculator 36.

The route evaluation value calculator 36 calculates the route evaluation value S of the own device on the basis of the link quality and the route evaluation value S of the transmission source included in the reception information (step S36). The route evaluation value S calculated here is the route evaluation value S of a route formed when the transmission source is the parent node. The route evaluation value calculator 36 inputs the calculated route evaluation value S to the connection destination decider 35.

The connection destination decider 35, to which the reception information and the route evaluation value S are input, stores the ID of the transmission source, the residual number of connections M of the transmission source, the number of same type devices D of the transmission source, and the route evaluation value S included in the input reception information in association with one another (step S37). The communicator 5, the connection destination decider 35, and the route evaluation value calculator 36 continue the processing explained above until the parent candidate search period ends.

In this embodiment, a deciding method for the parent candidate in step S34 is different from the deciding method in the first embodiment. In this embodiment, the connection destination decider 35 decides a parent candidate on the basis of the residual numbers of connections M, the numbers of same type devices D, and the route evaluation values S of the other devices.

The connection destination decider 35 decides, as the parent candidate, for example, the other device having the best route evaluation value S among the other devices, the residual numbers of connections M of which are the largest (or equal to or larger than the threshold M_{TH}). The best route evaluation value S means that the quality of a route meant by the route evaluation value S is the highest. When the route evaluation value S is larger as the quality of the route is higher, the other device having the largest route evaluation value S is the other device having the best route evaluation value.

The connection destination decider 35 may decide, as the parent candidate, the other device having the smallest number of same type devices D among the other devices, the residual numbers of connections M of which are the largest (or equal to or larger than the threshold M_{TH}).

The connection destination decider 35 may prioritize the comparison of the route evaluation values S or the numbers of same type devices D over the comparison of the residual numbers of connections M. For example, the connection destination decider 35 may decide, as the parent candidate, the other device having the largest residual number of connections M among the other devices, the route evaluation values S of which are the best or better than a threshold S_{TH}. The connection destination decider 35 may decide, as the parent candidate, the other device having the largest residual number of connections M among the other devices, the numbers of same type devices D of which are the smallest or equal to or smaller than a threshold D_{TH}.

The connection destination decider 35 may decide the parent candidate using all of the residual number of connections M, the route evaluation value S, and the number of same type devices D.

As explained above, in this embodiment, the parent candidate is decided using the residual number of connections M, the route evaluation value S, and the number of same type devices D. Since the connection destination decider 35 decides the other device having the satisfactory route evaluation value S as the parent candidate, the wireless communication device can form a high-quality route and improve stability of the network.

Since the connection destination decider 35 decide the other device having the small number of same type devices D as the parent candidate, it is possible to reduce a maximum of a payload size in the wireless communication device, the number of hops of which is 1. This is because, as the number of same type devices D is larger, a payload size of the wireless communication device serving as a start point of a subtree of the devices is larger.

Since the connection destination decider 35 decides, as the parent candidate, the other device, the number of same type devices D of which is equal to or smaller than the predetermined threshold D_{TH}, it is possible to reduce a maximum of a payload size in the network to be smaller than a predetermined value (e.g., a maximum payload size transmittable on the network).

Note that, in this embodiment, the wireless communication device, the number of same type devices D of which is larger than the threshold D_{TH} may always reject connection of the other devices. This is enabled by the connection margin calculator 32 calculating the residual number of connections M as 0 or the connection acceptance determiner determining that the connection is always rejected. According to such processing, it is possible to reduce the maximum of the payload size.

In this embodiment, it is also possible to calculate, as the maximum number of connections L, a value obtained by dividing a remaining data size, which remains after header information and the like is subtracted from a maximum payload size, by an average of data sizes of sensor data of the wireless communication devices, acquire the number of same type devices D as the number of connections N, and calculate the residual number of connections M.

The connection destination decider 35 of the present embodiment is one of the examples of a first decider and a second decider in the claims, and the route evaluation value calculator 36 of the present embodiment is one of the examples of a route evaluation value calculator in the claims.

### Third Embodiment

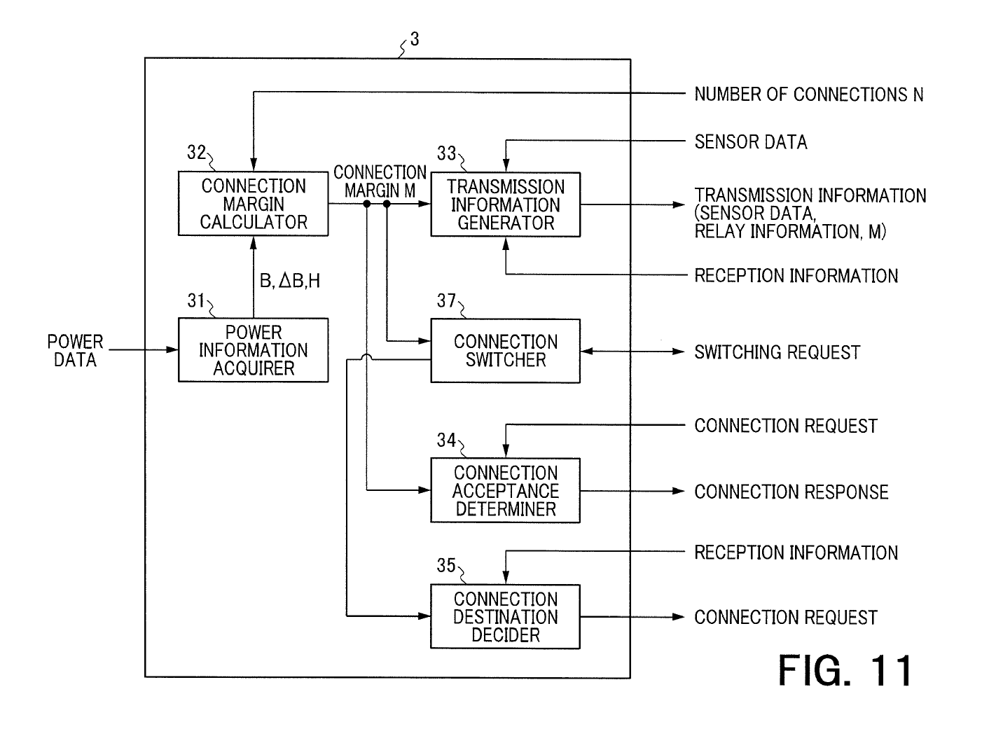

A wireless communication device according to a third embodiment is explained with reference to FIG. 11. The wireless communication device according to this embodiment requests another device connected to the own device to switch connection when the connection margin M of the own device is small.

FIG. 11 is a diagram showing an example of a functional configuration of the connection manager 3 of the wireless communication device according to this embodiment. The connection manager 3 shown in FIG. 11 includes a connection switcher 37. The other components are the same as the components of the connection manager 3 shown in FIG. 3. In the following explanation, differences from the first embodiment are mainly explained.

The connection switcher 37 controls switching of connection on the basis of the residual number of connections M of the own device. Specifically, when the residual number of connections M of the own device is smaller than the threshold M_{TH} and the number of connections N is equal to or larger than 1, the connection switcher 37 generates a switching notification or a switching request and inputs the switching notification or the switching request to the communicator 5.

The switching notification means a signal for notifying an end of connection to at least a part of a parent node to which the own device is connected. When the own device is connected to a plurality of parent nodes, by ending connection to a part of the parent nodes, although redundancy of routes decreases, it is possible to reduce the number of connections N of the own device and increase the number of residual connections M of the own device.

When generating the switching notification, the connection switcher 37 designates a parent node set as a notification target. The communicator 5 transmits the input switching notification to the notification target parent node and thereafter ends connection to the notification target parent node. The communicator 5 only has to end the connection to the notification target parent node without transmitting the input switching notification.

The connection switcher 37 may generate switching notifications to all parent nodes being connected. In this case, after communication with all the parent nodes ends, the connection switcher 37 causes the connection destination decider 35 to execute the parent candidate search processing. In this case, the connection destination decider 35 desirably searches for a parent candidate such that the number of hops of the own device is larger than an original number of hops. Consequently, it is possible to increase an average number of hops in a network and prevent a power consumption amount C of a specific wireless communication device from relatively increasing.

The switching request is a signal for requesting at least a part of child node connected to the own device to change connection destinations. By ending the connection to a part of the child nodes, it is possible to reduce the number of connections N of the own device and increase the residual number of connections M of the own device. The communicator 5 transmits the input switching request.

When generating the switching request, the connection switcher 37 may designate a child node set as a request target. The connection switcher 37 only has to select, as the request target, a child node having low link quality, for example, referring to link quality between the own device and the child nodes.

When the connection switcher 37 designates the child node set as the request target, the communicator 5 transmits the switching request to the request target child node. Specifically, the communicator 5 only has to transmit, as the switching request, a data frame including a predetermined command indicating the switching request and an ID of the request target child node.

When generating the switching request, the connection switcher 37 does not have to designate the child node set as the request target. When the connection switcher 37 does not designate the child note set as the request target, the communicator 5 broadcasts the switching request. Specifically, the communicator 5 only has to broadcast, as the switching request, a data frame including the predetermined command indicating the switching request.

Note that the data frame transmitted as the switching request may be a data frame exclusive for the switching request, may be a data frame for network control, or may be transmission information including sensor data. When the switching request is included in the transmission information, a child node can receive the switching request by executing reception processing in a transmission slot of the parent node. The switching request may include information such as the number of connections N and the residual number of connections M of the own device.

In this embodiment, when receiving the switching request from the parent node, the communicator 5 inputs the received switching request to the connection switcher 37. The connection switcher 37, to which the switching request is input, checks whether a request target of the switching request is the own device. That is, the connection switcher 37 checks whether an ID of the request target and an ID of the won device coincide with each other. When the request target is the own device, the connection switcher 37 causes the connection destination decider 35 to execute the parent candidate search processing. In this embodiment, when the own device cannot be connected to a new parent node according to the parent candidate search processing, the connection destination decider 35 may connect the own device to an original parent node again.

On the other hand, when the communicator 5 receives the broadcasted switching request, the connection switcher 37, to which the switching request is input, may or may not cause the connection destination decider 35 to execute the parent candidate search processing.

For example, the connection switcher 37 calculates a probability on the basis of the number of connections N and the residual number of connections M included in the switching request and decides according to the probability whether to cause the connection destination decider 35 to execute the parent candidate search processing. Specifically, it is conceivable that the connection switcher 37 causes the connection destination decider 35 to execute the parent candidate search processing at a probability of 1/N.

As explained above, the wireless communication device according to this embodiment can reduce the other devices connected to the own device and increase the connection margin M according to the switching notification or the switching request when the connection margin M of the own device is small. Consequently, it is possible to extend the life of the wireless network and stabilize the network.

The connection switcher 37 of the present embodiment is one of the examples of a connection switcher in the claims.

### Fourth Embodiment

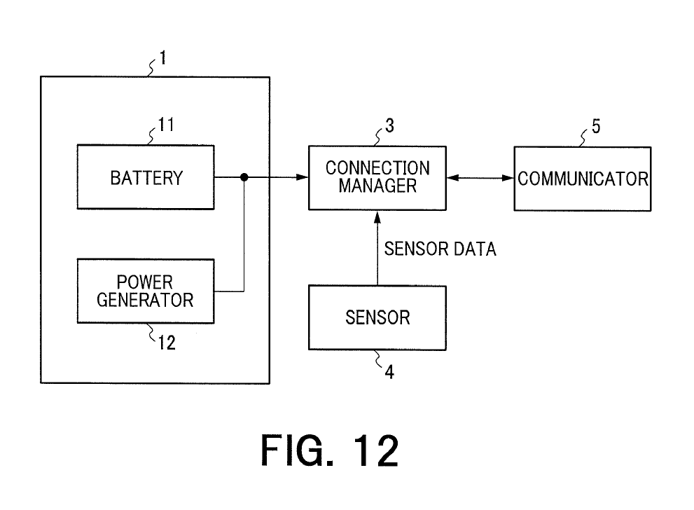

A wireless communication device according to a fourth embodiment is explained with reference to FIGS. 12 to 14. The wireless communication device according to this embodiment operates as a child node of the wireless communication device according to any one of the first to third embodiments. The wireless communication device according to this embodiment calculates the connection margin M of another device on the basis of power information of the other device and determines a parent candidate of the own device on the basis of the calculated connection margin M of the other device.

FIG. 12 is a diagram showing an example of the wireless communication device according to this embodiment. The wireless communication device shown in FIG. 12 includes the power supply 1, the connection manager 3, the sensor 4, and the communicator 5. The wireless communication device according to this embodiment does not have to include the power supply 1 and may be supplied with electric power from an external power supply or may include the measurer 2 like the wireless communication devices according to the first to third embodiments.

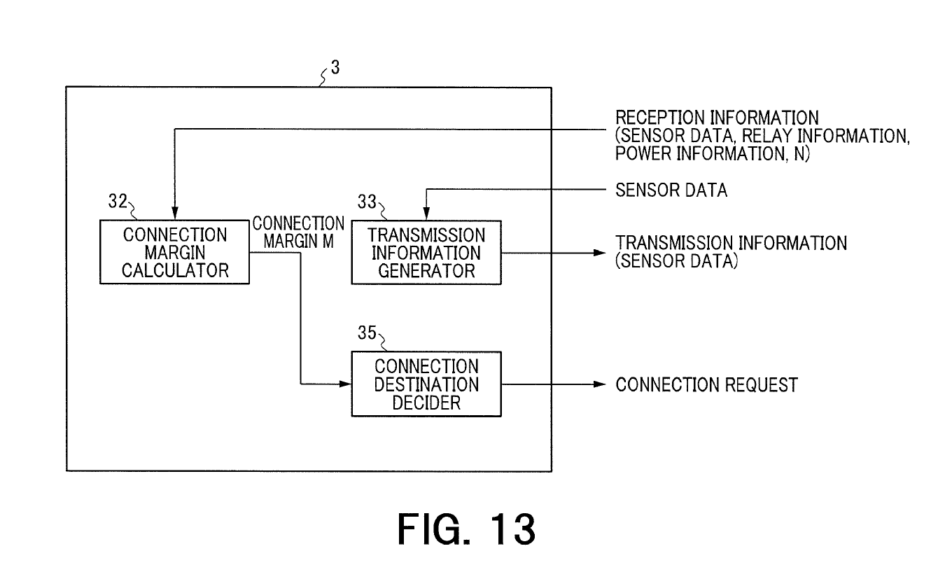

FIG. 13 is a diagram showing an example of a functional configuration of the connection manager 3 of the wireless communication device according to this embodiment. The connection manager 3 shown in FIG. 13 includes the connection margin calculator 32, the transmission information generator 33, and the connection destination decider 35. In the following explanation, differences from the first embodiment are mainly explained.

In this embodiment, the transmission information of the other device includes power information and the number of connections N of the other device. The other device is the wireless communication device according to any one of the first to third embodiments. This embodiment is based on the premise that the transmission information generator 33 of the other device generates the transmission information including the power information and the number of connections N.

When receiving reception information (transmission information of the other device) from the other device, the communicator 5 of the wireless communication device according to this embodiment inputs the reception information to the connection margin calculator 32. The connection margin calculator 32 calculates the residual number of connections M of the other device on the basis of the power information and the number of connections N included in the reception information. A calculation method for the residual number of connections M is as explained above.

The connection margin calculator 32, which has calculated the residual number of connections M, inputs an ID and the residual number of connections M of the other device to the connection destination decider 35. The connection destination decider 35 stores the ID and the residual number of connections M of the other device input to the connection destination decider 35. The connection destination decider 35 decides a parent candidate on the basis of the stored residual number of connections M of the other device. A decision method for the parent candidate is as explained above.

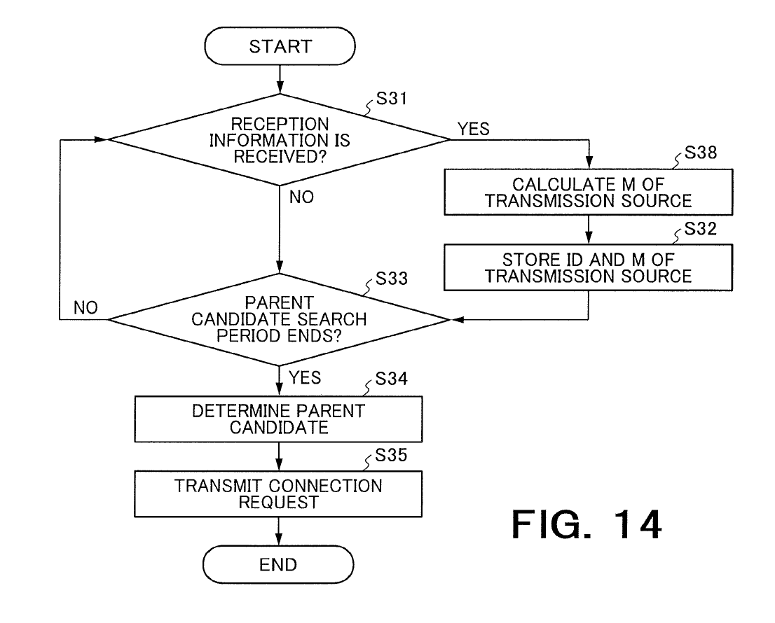

FIG. 14 is a flowchart for explaining parent candidate search processing of the wireless communication device. Steps S31 to S35 in the flowchart of FIG. 14 are the same as the steps in the flowchart of FIG. 7.

In this embodiment, when receiving reception information during reception processing (YES in step S31), the communicator 5 inputs the reception information to the connection margin calculator 32. The connection margin calculator 32 calculates the residual number of connections M of the other device on the basis of the power information and the number of connections N included in the reception information (step S38).

The connection margin calculator 32, which has calculated the residual number of connections M, inputs an ID and the residual number of connections M of a transmission source to the connection destination decider 35. The connection destination decider 35 stores the ID and the residual number of connections M of the transmission source input to the connection destination decider 35 (step S32). The communicator 5, the connection margin calculator 32, and the connection destination decider 35 repeat the processing explained above in a parent candidate search period.

When the parent candidate search period ends (YES in step S33), the connection destination decider 35 decides a parent candidate on the basis of the residual number of connections M stored in the parent candidate search period (step S34). Note that, in an example shown in FIG. 14, the calculation of the residual number of connections M of the transmission source is performed every time the reception information is received. However, the calculation of the residual number of connections M of the transmission source may be collectively performed after an end of the parent candidate search period.

As explained above, the wireless communication device according to this embodiment calculates the connection margin M of the other device on the basis of the power information of the other device. Therefore, even when a connection margin is not obtained from the other device, as in the first embodiment, it is possible to extend the life of a wireless network and stabilize the network.

Note that, in the above explanation, the power information of the other device is included in the transmission information of the other device. However, power information of the other device may be included in the transmission information of the other device. In this case, the wireless communication device according to this embodiment only has to acquire the power information of the other device and calculate the connection margin M of the other device on the basis of the power data of the other device.

The number of same type devices D and the route evaluation value S of the other device may be included in the transmission information of the other device. In this case, the connection destination decider 35 can decide a parent candidate using the number of same type devices D of the other device, the route evaluation value S of the own device in the case in which the other device is set as the parent node, and the like. A decision method for the parent candidate using the number of same type devices D and the route evaluation value S is as explained above.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A wireless communication device comprising:
a transmitter configured to transmit information; and
a controller configured to control the transmitter and:
calculate a communication amount for additional communication with another device on the basis of power information indicating a power state of a power supply; and
determine whether the wireless communication device connect to the another device at least in part based on the calculated communication amount.

2. The wireless communication device according to claim 1, wherein the communication amount is represented by a number of the other devices additionally connectable to the wireless communication device.

3. The wireless communication device according to claim 1, wherein the wireless communication device rejects a connection request from the other device when the communication amount is smaller than a predetermined threshold.

4. The wireless communication device according to claim 1, wherein the wireless communication device decides a candidate of a parent node on the basis of the communication amount of the other device.

5. The wireless communication device according to claim 1, wherein the wireless communication device transmits transmission information including the communication amount.

6. The wireless communication device according to claim 1, further comprising a route evaluation value calculator configured to calculate a route evaluation value indicating quality of a communication route for information from the own device to a root node.

7. The wireless communication device according to claim 6, wherein the route evaluation value calculator calculates the route evaluation value of the own device on the basis of the route evaluation value of the other device and link quality from the own device to the other device.

8. The wireless communication device according to claim 6, further comprising a first decider configured to decide the parent candidate on the basis of the route evaluation value.

9. The wireless communication device according to claim 6, further comprising a second decider configured to decide the parent candidate on the basis of a number of same type devices indicating a total number of nodes included in a subtree to which the own device belongs.

10. The wireless communication device according to claim 1, further comprising a connection switcher configured to control switching of the connection on the basis of the communication amount.

11. A wireless communication system comprising:
an aggregation device;
a first wireless communication device configured to transmit a connection response when the number of other wireless communication devices to be connected is decided to be capable to be increased on the basis of a power state of a power supply; and
a second wireless communication device configured to transmit information addressed to the aggregation device to the first wireless communication device when the second wireless communication device receives the connection response from the first wireless communication device after the second wireless communication device has transmitted a connection request to the first wireless communication device.

12. The wireless communication system according to claim 11, further comprising a third wireless communication device,
wherein the second wireless communication device transmits the connection request to the third wireless communication device when the second wireless communication device does not receive the connection response from the first wireless communication device after the second wireless communication device transmitted the connection request to the first wireless communication device.

13. The wireless communication device, comprising:
a transmitter configured to transmit information; and
a controller configured to control the transmitter and to increase the number of other wireless communication devices to be connected when a communication amount is more than a threshold value, the communication amount is calculated based on at least one of a residual electric energy, a power change amount, and a power generation amount of the power supply.

14. The wireless communication device according to claim 13, the communication amount is a communication amount when the number of the other wireless communication devices to be connected is increased.

15. The wireless communication device according to claim 13, the communication amount is calculated also based on the number of the other wireless communication devices currently connected to the wireless communication device.
